(19) United States
(12) Patent Application Publication
(10) Pub. No.: US 2017/0314849 A1
(43) Pub. Date: Nov. 2, 2017

(54) METHOD AND APPARATUS FOR CONTROLLING COOLING IN WATER DISPENSER

(71) Applicants: GUANGDONG MIDEA WATER DISPENSER MFG. CO., LTD., Foshan (CN); MIDEA GROUP CO., LTD., Foshan (CN)

(72) Inventors: Jianzhou XIE, Foshan (CN); Xingfan LI, Foshan (CN); Long MA, Foshan (CN)

(21) Appl. No.: 14/773,713

(22) PCT Filed: Jan. 16, 2015
(86) PCT No.: PCT/CN2015/070922

§ 371 Date: Sep. 8, 2015

(51) Int. Cl. F25D 29/00; A47J 31/56; B67D 1/08; F25D 31/00

(52) U.S. Cl. CPC F25D 29/00; F25D 31/002; B67D 1/0858; B67D 1/0888; A47J 31/56; F25D 2700/10; F25D 2700/14; F25D 2700/16

(57) ABSTRACT

A method and an apparatus for controlling a cooling in a water dispenser are disclosed. The method includes: S1, receiving a cooling instruction and entering a cooling mode according to the cooling instruction; S2, obtaining an operation parameter of the water dispenser; S3, determining whether a suspending condition is satisfied according to the operation parameter; S4, suspending a cooling if the suspending condition is satisfied; and S5, further determining whether a restarting condition is satisfied, performing the cooling and executing steps S2-S5 repeatedly until a cooling terminating condition is satisfied if the restarting condition is satisfied. Therefore, during the process of operating of the water dispenser, performances of the condenser and the evaporator may be restored to the optimal performance state by suspending the cooling, and when operating next, the evaporating temperature may drop very low, so that the performances of the condenser, the evaporator and the compressor may be developed multiple times, thus realizing the ultralow water temperature cooling and improving the cooling capacity.

### CROSS-REFERENCE TO RELATED APPLICATION

This application is a U.S. national phase application of International Application No. PCT/CN2015/070922, filed on Jan. 16, 2015, which is based upon and claims priority to Chinese Patent Application No. 201510023758.1, the entirety contents of which are incorporated herein by reference.

### FIELD

The present disclosure relates to the field of electrical appliance technologies, and more particularly, to a method for controlling a cooling in a water dispenser and an apparatus for controlling a cooling in a water dispenser.

### BACKGROUND

For a drinking water device industry, due to limitations of cost factors thereof, cooling capacities of related drinking water devices are generally designed at about two liters. If the cooling capacities are further improved, costs required by the drinking water devices will be increased greatly, thus losing price competitiveness.

There are following disadvantages in the related art.

The first is that, condensers of the related drinking water devices cannot meet performance requirements of an ultra-low temperature. This is because when a condenser temperature rises to a certain temperature, an evaporating temperature of the drinking water devices will not change and cooling apparatuses of the drinking water devices lose adjustment ability, resulting in overload running for a long time for the drinking water devices. If the condensers are replaced with condensers with a stronger cooling capacity, even though the above situation may be improved, the costs may be increased greatly. In addition, sizes of drinking fountains are very small, thus resulting in limitations on sizes of the condensers.

The second is that, compressors of the related drinking water devices cannot meet the performance requirements of the ultra-low temperature. This is because if the performance requirement of the ultra-low temperature is to be achieved, the evaporating temperature of the drinking water devices should be designed to be very low and a compressor air displacement also needs to be increased accordingly. If the compressors are replaced with ones with a larger air displacement, the product costs will be increased accordingly. Further, in order to match the compressors, corresponding evaporators are also made very large and capillaries are made very long, which will increase the costs.

Therefore, by increasing the compressor air displacement, enlarging the sizes of the condenser and evaporator, and extending the length of the capillaries so as to improve the cooling capacities of the drinking water devices, the production costs will be increased greatly, thus making it difficult for users to accept and reducing market competitiveness of products.

### SUMMARY

A method for controlling a cooling in a water dispenser according to embodiments of an aspect of the present disclosure includes: S1, receiving a cooling instruction and entering a cooling mode according to the cooling instruction; S2, obtaining an operation parameter of the water dispenser; S3, determining whether a suspending condition is satisfied according to the operation parameter; S4, suspending a cooling if the suspending condition is satisfied; and S5, further determining whether a restarting condition is satisfied, if the restarting condition is satisfied performing the cooling, and executing steps S2-S5 repeatedly until a cooling terminating condition is satisfied.

With the method for controlling a cooling in a water dispenser according to embodiments of the present disclosure, when entering the cooling mode, the operation parameter of the water dispenser is obtained, and it is determined whether the suspending condition is satisfied according to the operation parameter, and the cooling is suspended if the suspending condition is satisfied, and it is further determined whether the restarting condition is satisfied, and if the restarting condition is satisfied, the cooling is performed and then it is determined repeatedly whether the suspending condition or the restarting condition is satisfied until the cooling terminating condition is satisfied. Therefore, during the process of operating of the water dispenser, performances of the condenser and the evaporator may be restored to the optimal performance state by suspending the cooling, and when operating next, the evaporating temperature may drop very low, so that the performances of the condenser, the evaporator and the compressor may be developed multiple times, thus realizing the ultralow water temperature cooling and improving the cooling capacity. In addition, with the method, the increase of the costs is also avoided, the deficiency of unstable performances caused by the overload operation of the condenser and the evaporator is avoided, and the stability of the water dispenser is improved.

In an embodiment of the present disclosure, the operation parameter is a condenser temperature of the water dispenser, in which if the condenser temperature is greater than a first preset temperature threshold, it is determined that the suspending condition is satisfied, and if the condenser temperature is less than a second preset temperature threshold, it is determined that the restarting condition is satisfied.

In an embodiment of the present disclosure, the operation parameter is a cooling time of the water dispenser, in which if the cooling time is greater than a first preset time threshold, it is determined that the suspending condition is satisfied, and if a suspending time is greater than a second preset time threshold, it is determined that the restarting condition is satisfied.

In an embodiment of the present disclosure, the operation parameter is a cold water temperature of the water dispenser, in which if the cold water temperature reaches one of a plurality of preset temperatures, it is determined that the suspending condition is satisfied.

In an embodiment of the present disclosure, the operation parameter is an evaporator temperature and a cold water temperature of the water dispenser, in which if a difference between the evaporator temperature and the cold water temperature is less than a third preset temperature threshold, it is determined that the suspending condition is satisfied.

In an embodiment of the present disclosure, the operation parameter is a condenser temperature and an ambient temperature of the water dispenser, in which if a difference between the condenser temperature and the ambient temperature is less than a fourth preset temperature threshold, it is determined that the suspending condition is satisfied.

In an embodiment of the present disclosure, if a suspending time is greater than a third preset time threshold, it is determined that the restarting condition is satisfied.

An apparatus for controlling a cooling in a water dispenser according to embodiments of another aspect of the present disclosure includes: a receiving module, configured to receive a cooling instruction from a user; a detecting module, configured to detect an operation parameter of the water dispenser; a controlling module, configured to control the water dispenser to enter a cooling mode according to the cooling instruction, to obtain the operation parameter, to determine whether a suspending condition is satisfied according to the operation parameter, to suspend a cooling if the suspending condition is satisfied, to further determine whether a restarting condition is satisfied, to perform the cooling if the restarting condition is satisfied, and then to determine repeatedly whether the operation parameter satisfies the suspending condition or the restarting condition until a cooling terminating condition is satisfied.

With the apparatus for controlling a cooling in a water dispenser according to embodiments of the present disclosure, when entering the cooling mode, the controlling module obtains the operation parameter of the water dispenser, and determines whether the suspending condition is satisfied according to the operation parameter, and suspends the cooling if the suspending condition is satisfied, and further determines whether the restarting condition is satisfied, and performs the cooling if the restarting condition is satisfied, and then determines repeatedly whether the suspending condition or the restarting condition is satisfied until the cooling terminating condition is satisfied. Therefore, during the process of operating of the water dispenser, performances of the condenser and the evaporator may be restored to the optimal performance state by suspending the cooling, and when operating next, the evaporating temperature may drop very low, so that the performances of the condenser, the evaporator and the compressor may be developed multiple times, thus realizing the ultralow water temperature cooling and improving the cooling capacity. In addition, with the apparatus, the increase of the costs is also avoided, the deficiency of unstable performances caused by the overload operation of the condenser and the evaporator is avoided, and the stability of the water dispenser is improved.

In an embodiment of the present disclosure, the operation parameter is a condenser temperature of the water dispenser, in which if the condenser temperature is greater than a first preset temperature threshold, the controlling module determines that the suspending condition is satisfied, and if the condenser temperature is less than a second preset temperature threshold, the controlling module determines that the restarting condition is satisfied.

In an embodiment of the present disclosure, the operation parameter is a cooling time of the water dispenser, in which if the cooling time is greater than a first preset time threshold, the controlling module determines that the suspending condition is satisfied, and if a suspending time is greater than a second preset time threshold, the controlling module determines that the restarting condition is satisfied.

In an embodiment of the present disclosure, the operation parameter is a cold water temperature of the water dispenser, in which if the cold water temperature reaches one of a plurality of preset temperatures, the controlling module determines that the suspending condition is satisfied.

In an embodiment of the present disclosure, the operation parameter is an evaporator temperature and a cold water temperature of the water dispenser, in which if a difference between the evaporator temperature and the cold water temperature is less than a third preset temperature threshold, the controlling module determines that the suspending condition is satisfied.

In an embodiment of the present disclosure, the operation parameter is a condenser temperature and an ambient temperature of the water dispenser, in which if a difference between the condenser temperature and the ambient temperature is less than a fourth preset temperature threshold, the controlling module determines that the suspending condition is satisfied.

In an embodiment of the present disclosure, if a suspending time is greater than a third preset time threshold, the controlling module determines that the restarting condition is satisfied.

The present disclosure also provides a non-transitory computer readable storage medium, including a computer program stored thereon, which when executed by a controller of the water dispenser, configures the water dispenser to implement the method for controlling a cooling in a water dispenser according to the above.

### BRIEF DESCRIPTION OF THE DRAWINGS

FIG. 1 is a flow chart of a method for controlling a cooling in a water dispenser according to an embodiment of the present disclosure;

FIG. 2 is a block diagram of an apparatus for controlling a cooling in a water dispenser according to an embodiment of the present disclosure.

### REFERENCE NUMERALS

receiving module 1, detecting module 2 and controlling module 3.

### DETAILED DESCRIPTION

Reference will be made in detail to embodiments of the present disclosure. The exemplary embodiments are shown in the accompanying drawings, in which the same or similar elements and the elements having same or similar functions are denoted by like reference numerals throughout the descriptions. The embodiments described herein with reference to accompanying drawings are explanatory, illustrative, and used to generally understand the present disclosure. The embodiments shall not be construed to limit the present disclosure.

In the following, a method and an apparatus for controlling a cooling in a water dispenser according to embodiments of the present disclosure will be described with reference to accompanying drawings.

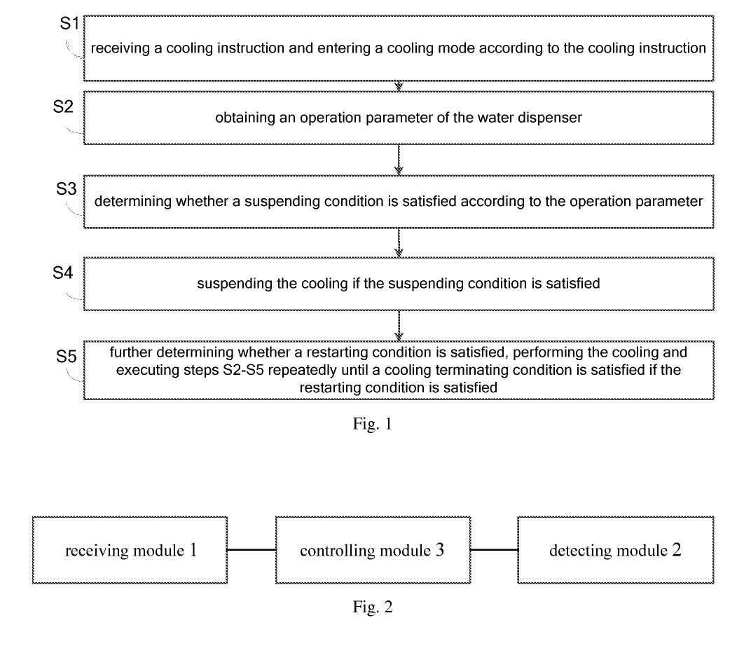

FIG. 1 is a flow chart of a method for controlling a cooling in a water dispenser according to an embodiment of the present disclosure. The water dispenser is configured to cool the water in the water storage container, and when a user does not use the water, to reserve the cold water with a low temperature, and when the user uses the water, to release a large amount of the cold water with the low temperature whenever necessary.

As shown in FIG. 1, the method for controlling a cooling in a water dispenser according to an embodiment of the present disclosure includes following steps.

In step S1, a cooling instruction is received and a cooling mode is entered according to the cooling instruction.

Under the cooling mode, the water dispenser operates the cooling, such that the water in the water dispenser may be cooled.

In step S2, an operation parameter of the water dispenser is obtained.

In some embodiments of the present disclosure, the operation parameter may be one or more of a condenser temperature, a cooling time, a cold water temperature, an evaporator temperature and an ambient temperature.

In step S3, it is determined whether a suspending condition is satisfied according to the operation parameter.

In step S4, the cooling is suspended if the suspending condition is satisfied.

In step S5, it is further determined whether a restarting condition is satisfied, and if the restarting condition is satisfied, the cooling is performed, and steps S2-S5 are executed repeatedly until a cooling terminating condition is satisfied.

In other words, during a process of executing steps S2-S5 recurrently, if the water temperature in the water dispenser drops to less than or equal to a preset target water temperature, it is determined that the cooling terminating condition is satisfied, and then the cooling mode is exited and the water dispenser is controlled to stop cooling.

When starting to perform the cooling operation, the water dispenser begins to cool the water in the water storage container. With an extension of the cooling time, a heat dissipation of the condenser in the water dispenser may reach the maximum, and the evaporating temperature cannot continue to drop, now it is determined that the operation parameter satisfies the suspending condition. And then, it may make the water dispenser suspend the cooling through various methods, so that the heat of the condenser and the compressor may be dispersed quickly to the outside world and the entire water dispenser may be adjusted to an optimal cooling state. Now it is determined that the operation parameter satisfies the restarting condition, and the water dispenser performs the cooling operation renewedly to continue to drop the water temperature in the water storage container. With the cooling time is continued to be extended, the heat dissipation of the condenser in the water dispenser may reach the maximum again. When the evaporating temperature cannot continue to drop, the water dispenser may suspend to cool again, the heat of the condenser and the compressor may be dispersed fast to the outside world, and the entire water dispenser may be adjusted to the optimal cooling state again, and then the water dispenser performs the cooling operation renewedly.

Such operation cycle continues until the water temperature in the water storage container drops very low, for example the water temperature drops to the preset target water temperature, thus completing the cooling.

In other words, by an intermittent cooling control way, the heat dissipation state of the water dispenser may be adjusted constantly, so that the entire water dispenser may be maintained at an efficient operation state for long periods until the water temperature drops to the preset target water temperature.

With the method for controlling a cooling in a water dispenser according to embodiments of the present disclosure, when entering the cooling mode, the operation parameter of the water dispenser is obtained, and it is determined whether the suspending condition is satisfied according to the operation parameter, and the cooling is suspended if the suspending condition is satisfied, and it is further determined whether the restarting condition is satisfied, and if the restarting condition is satisfied, the cooling is performed and then it is determined repeatedly whether the suspending condition or the restarting condition is satisfied until the cooling terminating condition is satisfied. Therefore, during the process of operating of the water dispenser, performances of the condenser and the evaporator may be restored to the optimal performance state by suspending the cooling, and when operating next, the evaporating temperature may drop very low, so that the performances of the condenser, the evaporator and the compressor may be developed multiple times, thus realizing the ultralow water temperature cooling and improving the cooling capacity. In addition, with the method, the increase of the costs is also avoided, the deficiency of unstable performances caused by the overload operation of the condenser and the evaporator is avoided, and the stability of the water dispenser is improved.

The method for controlling a cooling in a water dispenser according to embodiments of the present disclosure will be described in detail with reference to exemplary embodiments as follows.

In an exemplary embodiment of the present disclosure, the operation parameter is the condenser temperature of the water dispenser, in which if the condenser temperature is greater than a first preset temperature threshold, it is determined that the suspending condition is satisfied, and if the condenser temperature is less than a second preset temperature threshold, it is determined that the restarting condition is satisfied. Certainly, it may be determined whether the restarting condition is satisfied according to other conditions, for example, whether the suspending time reaches a time threshold.

It should be noted that, the condenser temperature may be detected by a first temperature sensor mounted in the condenser. More specifically, the first temperature sensor may be mounted at an end of the condenser to detect a temperature of the end of the condenser.

When the water dispenser performs the cooling operation, the cold water temperature begins to drop and the condenser temperature begins to rise. When the condenser temperature reaches the first preset temperature threshold, it is determined that the suspending condition is satisfied, and the water dispenser suspends the cooling. And then the condenser dissipates the heat quickly to the air and the condenser temperature drops quickly. When the condenser temperature drops to less than the second preset temperature threshold, it is determined that the restarting condition is satisfied, and the water dispenser preforms the cooling operation renewedly. Such operation cycle continues until the water temperature in the water storage container drops very low, for example the water temperature drops to the preset target water temperature. So the cooling is completed by the intermittent cooling control way.

In another exemplary embodiment of the present disclosure, the operation parameter may be the cooling time of the water dispenser, in which if the cooling time is greater than a first preset time threshold, it is determined that the suspending condition is satisfied, and if the suspending time is greater than a second preset time threshold, it is determined that the restarting condition is satisfied. Certainly, it may be determined whether the restarting condition is satisfied according to other conditions, for example, whether the condenser temperature is less than the preset temperature threshold.

It should be noted that, the cooling time may be timed by a first timer and the suspending time may be timed by a second timer. More specifically, when the water dispenser enters the cooling mode, the first timer may be controlled to time from 0 thus recording the cooling time; when the water dispenser suspends the cooling, the second timer may be controlled to time from 0 thus recording the suspending time.

The first preset time threshold may be set in the water dispenser first and then the second preset time threshold may be set in the water dispenser. When the water dispenser performs the cooling operation, the cold water temperature begins to drop. When the cooling time of the water dispenser reaches the first preset time threshold, it is determined that the suspending condition is satisfied. Now the heat dissipation of the condenser reaches the maximum, the evaporating temperature cannot continue to drop and the water dispenser suspends the cooling. And then the condenser dissipates the heat quickly to the air. When the suspending time reaches the second preset time threshold, the water dispenser may be adjusted to the optimal cooling state and it is determined that the restarting condition is satisfied, and the water dispenser preforms the cooling operation renewedly. Such operation cycle continues until the water temperature in the water storage container drops very low, for example the water temperature drops to the preset target water temperature. The cooling is completed by the intermittent cooling control way.

In yet another exemplary embodiment of the present disclosure, the operation parameter may be the cold water temperature of the water dispenser, in which if the cold water temperature reaches one of a plurality of preset temperatures, it is determined that the suspending condition is satisfied.

It should be noted that, the cold water temperature may be detected by a second temperature sensor mounted at the water storage container.

Further, when the suspending time is greater than a third preset time threshold, it is determined that the restarting condition is satisfied. Certainly, it may be determined whether the restarting condition is satisfied according to other conditions, for example, whether the condenser temperature is less than the preset temperature threshold.

It should be noted that, the suspending time may be timed by a third timer. More specifically, when the water dispenser suspends the cooling, the third timer may be controlled to time from 0 thus recording the suspending time.

When the water dispenser starts to perform the cooling operation, the cold water temperature begins to drop toward one of the plurality of preset temperatures. When the temperature of the normal temperature water drops to the one of the plurality of preset temperatures, the heat dissipation of the condenser reaches the maximum, the evaporating temperature cannot continue to drop and the water dispenser suspends the cooling. And then the condenser dissipates the heat quickly to the air. When the suspending time reaches the third preset time threshold, the water dispenser may be adjusted to the optimal cooling state and it is determined that the restarting condition is satisfied. Then the water dispenser preforms the cooling operation renewedly, and the water temperature drops toward another one of the plurality of preset temperatures. When the water temperature reaches the another one of the plurality of preset temperatures, the heat dissipation of the condenser reaches the maximum and the water dispenser suspends the cooling. When the suspending time reaches the third preset time threshold, the water dispenser may be adjusted to the optimal cooling state and the water dispenser performs the cooling renewedly. Such operation cycle continues until the water temperature in the water storage container drops very low, for example the water temperature drops to the preset target water temperature. The cooling is completed by the intermittent cooling control way.

In addition, it should be noted that, the plurality of preset temperatures may be sequenced by a descending order and thus the cold water temperature may drop to the preset target water temperature by the intermittent cooling control way. For example, the plurality of preset temperatures may include a water temperature 1, a water temperature 2 and a water temperature 3, in which the water temperature 1 is greater than the water temperature 2, and the water temperature 2 is greater than the water temperature 3 and the water temperature 3 is used as the preset target water temperature. Thus, when the water dispenser performs the cooling operation, the cold water temperature firstly drops toward the water temperature 1. When the cold water temperature reaches the water temperature 1, the water dispenser suspends the cooling. When the suspending time reaches the third preset time threshold, the water dispenser preforms the cooling operation renewedly, and the cold water temperature drops toward the water temperature 2. When the cold water temperature reaches the water temperature 2, the water dispenser suspends the cooling. When the suspending time reaches the third preset time threshold, the water dispenser preforms the cooling operation renewedly, and the cold water temperature drops toward the water temperature 3. When the cold water temperature reaches the water temperature 3, the cold water temperature reaches the preset target water temperature thus stopping the cooling.

In still another exemplary embodiment of the present disclosure, the operation parameter may be the evaporator temperature and the cold water temperature of the water dispenser, in which if a difference between the evaporator temperature and the cold water temperature is less than a third preset temperature threshold, it is determined that the suspending condition is satisfied.

It should be noted that, the condenser temperature may be detected by a third temperature sensor mounted in the condenser, and the cold water temperature may be detected by the second temperature sensor mounted in the water storage container.

Further, when the suspending time is greater than the third preset time threshold, it is determined that the restarting condition is satisfied. Certainly, it may be determined whether the restarting condition is satisfied according to other conditions, for example, whether the condenser temperature is less than the preset temperature threshold.

It should be noted that, the suspending time may be timed by the third timer. More specifically, when the water dispenser suspends the cooling, the third timer may be controlled to time from 0 thus recording the suspending time.

When the water dispenser starts to perform the cooling operation, the cold water temperature begins to drop. When the difference between the evaporator temperature and the cold water temperature is less than the third preset temperature threshold, it is determined that the suspending condition is satisfied. The water dispenser suspends the cooling, and the condenser dissipates the heat quickly to the air. When the suspending time reaches the third preset time threshold, the water dispenser may be adjusted to the optimal cooling state and it is determined that the restarting condition is satisfied. Then the water dispenser preforms the cooling operation renewedly, and the water temperature continues to drop. When the difference between the evaporator temperature and the reduced cold water temperature is less than the third preset temperature threshold, the water dispenser suspends the cooling again. When the suspending time reaches the third preset time threshold, the water dispenser may be adjusted to the optimal cooling state and the water dispenser preforms the cooling operation renewedly. Such operation cycle continues until the water temperature in the water storage container drops very low, for example the water temperature drops to the preset target water temperature. The cooling is completed by the intermittent cooling control way.

In yet still another exemplary embodiment of the present disclosure, the operation parameter may be the condenser temperature and the ambient temperature of the water dispenser, in which if a difference between the condenser temperature and the ambient temperature is less than a fourth preset temperature threshold, it is determined that the suspending condition is satisfied.

It should be noted that, the condenser temperature may be detected by the first temperature sensor mounted in the condenser, and the ambient temperature may be detected by a fourth temperature sensor mounted in the housing of the water dispenser. More specifically, the first temperature sensor may be mounted at the end of the condenser to detect the temperature of the end of the condenser.

Further, when the suspending time is greater than the third preset time threshold, it is determined that the restarting condition is satisfied. Certainly, it may be determined whether the restarting condition is satisfied according to other conditions, for example, whether the condenser temperature is less than the preset temperature threshold.

It should be noted that, the suspending time may be timed by the third timer. More specifically, when the water dispenser suspends the cooling, the third timer may be controlled to time from 0 thus recording the suspending time.

When the water dispenser starts to perform the cooling operation, the cold water temperature begins to drop and the condenser temperature begins to rise. When the difference between the condenser temperature and the ambient temperature is less than the fourth preset temperature threshold, it is determined that the suspending condition is satisfied. The water dispenser suspends the cooling, and the condenser dissipates the heat quickly to the air and the condenser temperature drops rapidly. When the suspending time reaches the third preset time threshold, the water dispenser may be adjusted to the optimal cooling state and it is determined that the restarting condition is satisfied. Then the water dispenser preforms the cooling operation renewedly, and the water temperature continues to drop again, and the condenser temperature continues to rise again. When the difference between the condenser temperature and the ambient temperature is less than the fourth preset temperature threshold, the water dispenser may suspend the cooling again. When the suspending time reaches the third preset time threshold, the water dispenser may be adjusted to the optimal cooling state and the water dispenser preforms the cooling operation renewedly. Such operation cycle continues until the water temperature in the water storage container drops very low, for example the water temperature drops to the preset target water temperature. The cooling is completed by the intermittent cooling control way.

In other words, the difference between the condenser temperature and the ambient temperature may be maintained at the maximum temperature difference, which facilitates the water dispenser to dissipate the heat quickly to the air. When the difference between the condenser temperature and the ambient temperature is less than the fourth preset temperature threshold, the water dispenser may stop cooling temporarily, allowing the heat of the condenser and the compressor to be quickly dissipated to the air. When being adjusted to the optimal cooling state, the water dispenser preforms the cooling operation renewedly. Such operation cycle continues until the cold water temperature drops below the preset target water temperature.

In addition, in other embodiments of the present disclosure, the condenser temperature, the cooling time, the cold water temperature, the difference between the evaporator temperature and the cold water temperature, and the difference between the condenser temperature and the ambient temperature may be combined to control the cooling. By combining the above determination conditions, the optimal cooling control way may be obtained, thus fully taking effects of the intermittent cooling control way.

In order to realize the above embodiments, the present disclosure also provides an apparatus for controlling a cooling in a water dispenser.

FIG. 2 is a block diagram of an apparatus for controlling a cooling in a water dispenser according to an embodiment of the present disclosure. The water dispenser is configured to cool the water in the water storage container, and when a user does not use the water, to reserve the cold water with a low temperature, and when the user uses the water, to release a large amount of the cold water with the low temperature whenever necessary.

As shown in FIG. 2, the apparatus for controlling a cooling in a water dispenser according to an embodiment of the present disclosure includes a receiving module 1, a detecting module 2 and a controlling module 3.

The receiving module 1 is configured to receive a cooling instruction from a user; the detecting module 2 is configured to detect an operation parameter of the water dispenser. In some embodiments of the present disclosure, the operation parameter may be one or more of a condenser temperature, a cooling time, a cold water temperature, an evaporator temperature and an ambient temperature.

The controlling module 3 is configured to control the water dispenser to enter a cooling mode according to the cooling instruction, to obtain the operation parameter, to determine whether a suspending condition is satisfied according to the operation parameter, to suspend a cooling if the suspending condition is satisfied, to further determine whether a restarting condition is satisfied, to perform the cooling if the restarting condition is satisfied, and to determine repeatedly whether the operation parameter satisfies the suspending condition or the restarting condition until a cooling terminating condition is satisfied.

In other words, under the cooling mode, the water dispenser performs the cooling operation to cool the water in the water dispenser. During a process of determining whether the operation parameter satisfies the suspending condition or the restarting condition continuously and recurrently, if the water temperature in the water dispenser drops to less than or equal to a preset target water temperature, it is determined that the cooling terminating condition is satisfied, and then the cooling mode is exited and the controlling module 3 controls the water dispenser to stop the cooling.

When starting to perform the cooling operation, the water dispenser begins to cool the water in the water storage container. With an extension of the cooling time, a heat dissipation of the condenser in the water dispenser may reach the maximum, and the evaporating temperature cannot continue to drop, now it is determined that the operation parameter satisfies the suspending condition. And then, the controlling module 3 may control the water dispenser to suspend the cooling through various methods, so that the heat of the condenser and the compressor may be dispersed quickly to the outside world and the entire water dispenser may be adjusted to an optimal cooling state. Now it is determined that the operation parameter satisfies the restarting condition, and the controlling module 3 controls the water dispenser to performs the cooling operation renewedly to continue to drop the water temperature in the water storage container. With the cooling time is continued to be extended, the heat dissipation of the condenser in the water dispenser may reach the maximum again. When the evaporating temperature cannot continue to drop, the water dispenser may have a short pause again, the heat of the condenser and the compressor may be dispersed fast to the outside world, and the entire water dispenser may be adjusted to the optimal cooling state again, and then the water dispenser performs the cooling operation renewedly.

Such operation cycle continues until the water temperature in the water storage container drops very low, for example the water temperature drops to the preset target water temperature, thus completing the cooling.

In other words, by an intermittent cooling control way, the heat dissipation state of the water dispenser may be adjusted constantly, so that the entire water dispenser may be maintained at an efficient operation state for long periods until the water temperature drops to the preset target water temperature.

With the apparatus for controlling a cooling in a water dispenser according to embodiments of the present disclosure, when entering the cooling mode, the controlling module obtains the operation parameter of the water dispenser, and determines whether the suspending condition is satisfied according to the operation parameter, and suspends the cooling if the suspending condition is satisfied, and further determines whether the restarting condition is satisfied, and performs the cooling if the restarting condition is satisfied, and then determines repeatedly whether the suspending condition or the restarting condition is satisfied until the cooling terminating condition is satisfied. Therefore, during the process of operating of the water dispenser, performances of the condenser and the evaporator may be restored to the optimal performance state by suspending the cooling, and when operating next, the evaporating temperature may drop very low, so that the performances of the condenser, the evaporator and the compressor may be developed multiple times, thus realizing the ultralow water temperature cooling and improving the cooling capacity. In addition, with the apparatus, the increase of the costs is also avoided, the deficiency of unstable performances caused by the overload operation of the condenser and the evaporator is avoided, and the stability of the water dispenser is improved.

The apparatus for controlling a cooling in a water dispenser according to embodiments of the present disclosure will be described in detail with reference to exemplary embodiments as follows.

In an exemplary embodiment of the present disclosure, the operation parameter is the condenser temperature of the water dispenser, in which if the condenser temperature is greater than a first preset temperature threshold, the controlling module 3 determines that the suspending condition is satisfied, and if the condenser temperature is less than a second preset temperature threshold, the controlling module 3 determines that the restarting condition is satisfied. Certainly, it may be determined whether the restarting condition is satisfied according to other conditions, for example, whether the suspending time reaches a time threshold.

It should be noted that, the detecting module 2 may include a first temperature sensor. The first temperature sensor may be mounted in the condenser to detect the condenser temperature. More specifically, the first temperature sensor may be mounted at the end of the condenser to detect the temperature of the end of the condenser.

When the water dispenser performs the cooling operation, the cold water temperature begins to drop and the condenser temperature begins to rise. When the condenser temperature reaches the first preset temperature threshold, the controlling module 3 determines that the suspending condition is satisfied, and the water dispenser suspends the cooling. And then the condenser dissipates the heat quickly to the air and the condenser temperature drops quickly. When the condenser temperature drops to less than the second preset temperature threshold, the controlling module 3 determines that the restarting condition is satisfied, and the water dispenser preforms the cooling operation renewedly. Such operation cycle continues until the water temperature in the water storage container drops very low, for example the water temperature drops to the preset target water temperature. So the cooling is completed by the intermittent cooling control way.

In another exemplary embodiment of the present disclosure, the operation parameter is the cooling time of the water dispenser, in which if the cooling time is greater than first preset time threshold, the controlling module 3 determines that the suspending condition is satisfied, and if the suspending time is greater than a second preset time threshold, the controlling module determines that the restarting condition is satisfied. Certainly, it may be determined whether the restarting condition is satisfied according to other conditions, for example, whether the condenser temperature is less than the preset temperature threshold.

It should be noted that, the cooling time may be timed by a first timer and the suspending time may be timed by a second timer. More specifically, when the water dispenser enters the cooling mode, the controlling module 3 controls the first timer to time from 0 thus recording the cooling time; when the water dispenser suspends the cooling, the controlling module 3 controls the second timer to time from 0 thus recording the suspending time.

The first preset time threshold may be set in the water dispenser first and then the second preset time threshold may be set in the water dispenser. When the water dispenser performs the cooling operation, the cold water temperature begins to drop. When the cooling time of the water dispenser reaches the first preset time threshold, the controlling module 3 determines that the suspending condition is satisfied. Now the heat dissipation of the condenser reaches the maximum, the evaporating temperature cannot continue to drop and the water dispenser suspends the cooling. And then the condenser dissipates the heat quickly to the air. When the suspending time reaches the second preset time threshold, the water dispenser may be adjusted to the optimal cooling state and the controlling module 3 determines that the restarting condition is satisfied, and the water dispenser preforms the cooling operation renewedly. Such operation cycle continues until the water temperature in the water storage container drops very low, for example the water temperature drops to the preset target water temperature. The cooling is completed by the intermittent cooling control way.

In yet another exemplary embodiment of the present disclosure, the operation parameter may be the cold water temperature of the water dispenser, in which if the cold water temperature reaches one of a plurality of preset temperatures, the controlling module 3 determines that the suspending condition is satisfied.

It should be noted that, the detecting module 2 may include a second temperature sensor. The second temperature sensor may be sensor mounted at the water storage container to detect the cold water temperature.

Further, when the suspending time is greater than a third preset time threshold, the controlling module 3 determines that the restarting condition is satisfied. Certainly, it may be determined whether the restarting condition is satisfied according to other conditions, for example, whether the condenser temperature is less than the preset temperature threshold.

It should be noted that, the suspending time may be timed by a third timer. More specifically, when the water dispenser stops the cooling, the controlling module 3 controls the third timer to time from 0 thus recording the suspending time.

When the water dispenser starts to perform the cooling operation, the cold water temperature begins to drop toward one of the plurality of preset temperatures. When the temperature of the normal temperature water drops to the one of the plurality of preset temperatures, the heat dissipation of the condenser reaches the maximum, the evaporating temperature cannot continue to drop and the controlling module 3 controls the water dispenser to suspend the cooling. And then the condenser dissipates the heat quickly to the air. When the suspending time reaches the third preset time threshold, the water dispenser may be adjusted to the optimal cooling state and the controlling module 3 determines that the restarting condition is satisfied. Then the water dispenser preforms the cooling operation renewedly, and the water temperature drops toward another one of the plurality of preset temperatures. When the water temperature reaches the another one of the plurality of preset temperatures, the heat dissipation of the condenser reaches the maximum and the controlling module 3 controls the water dispenser to suspend the cooling. When the suspending time reaches the third preset time threshold, the water dispenser may be adjusted to the optimal cooling state and the water dispenser performs the cooling renewedly. Such operation cycle continues until the water temperature in the water storage container drops very low, for example the water temperature drops to the preset target water temperature. The cooling is completed by the intermittent cooling control way.

In addition, it should be noted that, the plurality of preset temperatures may be sequenced by a descending order and thus the cold water temperature may drop to the preset target water temperature by the intermittent cooling control way. For example, the plurality of preset temperatures may include a water temperature 1, a water temperature 2 and a water temperature 3, in which the water temperature 1 is greater than the water temperature 2, and the water temperature 2 is greater than the water temperature 3 and the water temperature 3 is used as the preset target water temperature. Thus, when the water dispenser performs the cooling operation, the cold water temperature firstly drops toward the water temperature 1. When the cold water temperature reaches the water temperature 1, the water dispenser suspends the cooling. When the suspending time reaches the third preset time threshold, the water dispenser preforms the cooling operation renewedly, and the cold water temperature drops toward the water temperature 2. When the cold water temperature reaches the water temperature 2, the water dispenser suspends the cooling. When the suspending time reaches the third preset time threshold, the water dispenser preforms the cooling operation renewedly, and the cold water temperature drops toward the water temperature 3. When the cold water temperature reaches the water temperature 3, the cold water temperature reaches the preset target water temperature thus stopping the cooling.

In still another exemplary embodiment of the present disclosure, the operation parameter may be the evaporator temperature and the cold water temperature of the water dispenser, in which if a difference between the evaporator temperature and the cold water temperature is less than a third preset temperature threshold, the controlling module 3 determines that the suspending condition is satisfied.

It should be noted that, the detecting module 2 may include a second temperature sensor and a third temperature sensor. The third temperature sensor may be mounted in the condenser to detect the condenser temperature, and the second temperature sensor may be mounted in the water storage container to detect the cold water temperature.

Further, when the suspending time is greater than the third preset time threshold, the controlling module 3 determines that the restarting condition is satisfied. Certainly, it may be determined whether the restarting condition is satisfied according to other conditions, for example, whether the condenser temperature is less than the preset temperature threshold.

It should be noted that, the suspending time may be timed by the third timer. More specifically, when the water dispenser suspends the cooling, the controlling module 3 controls the third timer to time from 0 thus recording the suspending time.

When the water dispenser starts to perform the cooling operation, the cold water temperature begins to drop. When the difference between the evaporator temperature and the cold water temperature is less than the third preset temperature threshold, the controlling module 3 determines that the suspending condition is satisfied. The water dispenser suspends the cooling, and the condenser dissipates the heat quickly to the air. When the suspending time reaches the third preset time threshold, the water dispenser may be adjusted to the optimal cooling state and the controlling module 3 determines that the restarting condition is satisfied. Then the water dispenser preforms the cooling operation renewedly, and the water temperature continues to drop. When the difference between the evaporator temperature and the reduced cold water temperature is less than the third preset temperature threshold, the controlling module 3 controls the water dispenser to suspend the cooling again. When the suspending time reaches the third preset time threshold, the water dispenser may be adjusted to the optimal cooling state and the water dispenser preforms the cooling operation renewedly. Such operation cycle continues until the water temperature in the water storage container drops very low, for example the water temperature drops to the preset target water temperature. The cooling is completed by the intermittent cooling control way.

In yet still another exemplary embodiment of the present disclosure, the operation parameter may be the condenser temperature and the ambient temperature of the water dispenser, in which if a difference between the condenser temperature and the ambient temperature is less than a fourth preset temperature threshold, the controlling module 3 determines that the suspending condition is satisfied.

It should be noted that, the detecting module 2 may include the first temperature sensor and a fourth temperature sensor. The first temperature sensor may be mounted in the condenser to detect the condenser temperature, and the fourth temperature sensor may be mounted in the housing of the water dispenser to detect the ambient temperature. More specifically, the first temperature sensor may be mounted at the end of the condenser to detect the temperature of the end of the condenser.

Further, when the suspending time is greater than the third preset time threshold, the controlling module 3 determines that the restarting condition is satisfied. Certainly, it may be determined whether the restarting condition is satisfied according to other conditions, for example, whether the condenser temperature is less than the preset temperature threshold.

It should be noted that, the suspending time may be timed by the third timer. More specifically, when the water dispenser suspends the cooling, the controlling module 3 controls the third timer to time from 0 thus recording the suspending time.

When the water dispenser starts to perform the cooling operation, the cold water temperature begins to drop and the condenser temperature begins to rise. When the difference between the condenser temperature and the ambient temperature is less than the fourth preset temperature threshold, the controlling module 3 determines that the suspending condition is satisfied. The water dispenser suspends the cooling, and the condenser dissipates the heat quickly to the air and the condenser temperature drops rapidly. When the suspending time reaches the third preset time threshold, the water dispenser may be adjusted to the optimal cooling state and the controlling module 3 determines that the restarting condition is satisfied. Then the water dispenser preforms the cooling operation renewedly, and the water temperature continues to drop again, and the condenser temperature continues to rise again. When the difference between the condenser temperature and the ambient temperature is less than the fourth preset temperature threshold, the water dispenser may suspend the cooling again. When the suspending time reaches the third preset time threshold, the water dispenser may be adjusted to the optimal cooling state and the water dispenser preforms the cooling operation renewedly. Such operation cycle continues until the water temperature in the water storage container drops very low, for example the water temperature drops to the preset target water temperature. The cooling is completed by the intermittent cooling control way.

In other words, the difference between the condenser temperature and the ambient temperature may be maintained at the maximum temperature difference, which facilitates the water dispenser to dissipate the heat quickly to the air. When the difference between the condenser temperature and the ambient temperature is less than the fourth preset temperature threshold, the water dispenser may stop cooling temporarily, allowing the heat of the condenser and the compressor to be quickly dissipated to the air. When being adjusted to the optimal cooling state, the water dispenser preforms the cooling operation renewedly. Such operation cycle continues until the cold water temperature drops below the preset target water temperature.

In addition, in other embodiments of the present disclosure, the controlling module 3 may combine the condenser temperature, the cooling time, the cold water temperature, the difference between the evaporator temperature and the cold water temperature, and the difference of the condenser temperature and the ambient temperature to control the cooling. By combining the above determination conditions, the optimal cooling control way may be obtained, thus fully taking effects of the intermittent cooling control way

In order to realize the above embodiments, the present disclosure also provides a non-transitory computer readable storage medium, comprising a computer program stored thereon, which when executed by a controller of the water dispenser, configures the water dispenser to implement the method for controlling a cooling in a water dispenser according to the above embodiments.

Reference throughout this specification to “one embodiment,” “some embodiments,” “an example,” “a specific example,” or “some examples,” means that a particular feature, structure, material, or characteristic described in connection with the embodiment or example is included in at least one embodiment or example of the present invention. Thus, the appearances of the phrases above in various places throughout this specification are not necessarily referring to the same embodiment or example of the present invention. Furthermore, the particular features, structures, materials, or characteristics may be combined in any suitable manner in one or more embodiments or examples. In addition, in the case of non-contradiction, different embodiments or examples or features in different embodiments or examples may be combined by those skilled in the art.

In addition, terms such as “first” and “second” are used herein for purposes of description and are not intended to indicate or imply relative importance or significance. Thus, the feature defined with “first” and “second” may comprise one or more this feature. In the description of the present disclosure, “a plurality of” means two or more than two, unless specified otherwise.

Any process or method described in a flow chart or described herein in other ways may be understood to include one or more modules, segments or portions of codes of executable instructions for achieving specific logical functions or steps in the process, and the scope of a preferred embodiment of the present disclosure includes other implementations, which should be understood by those skilled in the art.

The logic and/or step described in other manners herein or shown in the flow chart, for example, a particular sequence table of executable instructions for realizing the logical function, may be specifically achieved in any computer readable medium to be used by the instruction execution system, device or equipment (such as the system based on computers, the system comprising processors or other systems capable of obtaining the instruction from the instruction execution system, device and equipment and executing the instruction), or to be used in combination with the instruction execution system, device and equipment. As to the specification, “the computer readable medium” may be any device adaptive for including, storing, communicating, propagating or transferring programs to be used by or in combination with the instruction execution system, device or equipment. More specific examples of the computer readable medium comprise but are not limited to: an electronic connection (an electronic device) with one or more wires, a portable computer enclosure (a magnetic device), a random access memory (RAM), a read only memory (ROM), an erasable programmable read-only memory (EPROM or a flash memory), an optical fiber device and a portable compact disk read-only memory (CDROM). In addition, the computer readable medium may even be a paper or other appropriate medium capable of printing programs thereon, this is because, for example, the paper or other appropriate medium may be optically scanned and then edited, decrypted or processed with other appropriate methods when necessary to obtain the programs in an electric manner, and then the programs may be stored in the computer memories.

It should be understood that each part of the present disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

Those skilled in the art shall understand that all or parts of the steps in the above exemplifying method of the present disclosure may be achieved by commanding the related hardware with programs. The programs may be stored in a computer readable storage medium, and the programs comprise one or a combination of the steps in the method embodiments of the present disclosure when run on a computer.

In addition, each function cell of the embodiments of the present disclosure may be integrated in a processing module, or these cells may be separate physical existence, or two or more cells are integrated in a processing module. The integrated module may be realized in a form of hardware or in a form of software function modules. When the integrated module is realized in a form of software function module and is sold or used as a standalone product, the integrated module may be stored in a computer readable storage medium.

The storage medium mentioned above may be read-only memories, magnetic disks or CD, etc.

Although explanatory embodiments have been shown and described, it would be appreciated by those skilled in the art that the above embodiments cannot be construed to limit the present invention, and changes, alternatives, and modifications can be made in the embodiments without departing from spirit, principles and scope of the present invention.

1. A method for controlling a cooling in a water dispenser, comprising the following acts performed by a controller of the water dispenser:
S1, receiving a cooling instruction and entering a cooling mode according to the cooling instruction;
S2, obtaining an operation parameter of the water dispenser;
S3, determining whether a suspending condition is satisfied according to the operation parameter;
S4, suspending a cooling if the suspending condition is satisfied; and
S5, further determining whether a restarting condition is satisfied, if the restarting condition is satisfied performing the cooling, and executing steps S2-S5 repeatedly until a cooling terminating condition is satisfied.

2. The method according to claim 1, wherein the operation parameter is a condenser temperature of the water dispenser, in which if the condenser temperature is greater than a first preset temperature threshold, it is determined that the suspending condition is satisfied, and if the condenser temperature is less than a second preset temperature threshold, it is determined that the restarting condition is satisfied.

3. The method according to claim 1, wherein the operation parameter is a cooling time of the water dispenser, in which if the cooling time is greater than a first preset time threshold, it is determined that the suspending condition is satisfied, and if a suspending time is greater than a second preset time threshold, it is determined that the restarting condition is satisfied.

4. The method according to claim 1, wherein the operation parameter is a cold water temperature of the water dispenser, in which if the cold water temperature reaches one of a plurality of preset temperatures, it is determined that the suspending condition is satisfied.

5. The cooling control method according to claim 1, wherein the operation parameter is an evaporator temperature and a cold water temperature of the water dispenser, in which if a difference between the evaporator temperature and the cold water temperature is less than a third preset temperature threshold, it is determined that the suspending condition is satisfied.

6. The cooling control method according to claim 1, wherein the operation parameter is a condenser temperature and an ambient temperature of the water dispenser, in which if a difference between the condenser temperature and the ambient temperature is less than a fourth preset temperature threshold, it is determined that the suspending condition is satisfied.

7. The method according to claim 4, wherein if a suspending time is greater than a third preset time threshold, it is determined that the restarting condition is satisfied.

8. An apparatus for controlling a cooling in a water dispenser, comprising:
a receiving module, configured to receive a cooling instruction from a user;
a detecting module, configured to detect an operation parameter of the water dispenser;
a controlling module, configured to control the water dispenser to enter a cooling mode according to the cooling instruction, to obtain the operation parameter, to determine whether a suspending condition is satisfied according to the operation parameter, to suspend a cooling if the suspending condition is satisfied, to further determine whether a restarting condition is satisfied, to perform the cooling if the restarting condition is satisfied, and then to determine repeatedly whether the operation parameter satisfies the suspending condition or the restarting condition until a cooling terminating condition is satisfied.

9. The apparatus according to claim 8, wherein the operation parameter is a condenser temperature of the water dispenser, in which if the condenser temperature is greater than a first preset temperature threshold, the controlling module determines that the suspending condition is satisfied, and if the condenser temperature is less than a second preset temperature threshold, the controlling module determines that the restarting condition is satisfied.

10. The apparatus according to claim 8, wherein the operation parameter is a cooling time of the water dispenser, in which if the cooling time is greater than a first preset time threshold, the controlling module determines that the suspending condition is satisfied, and if a suspending time is greater than a second preset time threshold, the controlling module determines that the restarting condition is satisfied.

11. The apparatus according to claim 8, wherein the operation parameter is a cold water temperature of the water dispenser, in which if the cold water temperature reaches one of a plurality of preset temperatures, the controlling module determines that the suspending condition is satisfied.

12. The apparatus according to claim 8, wherein the operation parameter is an evaporator temperature and a cold water temperature of the water dispenser, in which if a difference between the evaporator temperature and the cold water temperature is less than a third preset temperature threshold, the controlling module determines that the suspending condition is satisfied.

13. The apparatus according to claim 8, wherein the operation parameter is a condenser temperature and an ambient temperature of the water dispenser, in which if a difference between the condenser temperature and the ambient temperature is less than a fourth preset temperature threshold, the controlling module determines that the suspending condition is satisfied.

14. The apparatus according to claim 11, wherein if a suspending time is greater than a third preset time threshold, the controlling module determines that the restarting condition is satisfied.

15. The method according to claim 5, wherein if a suspending time is greater than a third preset time threshold, it is determined that the restarting condition is satisfied.

16. The method according to claim 6, wherein if a suspending time is greater than a third preset time threshold, it is determined that the restarting condition is satisfied.

17. The apparatus according to claim 11, wherein if a suspending time is greater than a third preset time threshold, the controlling module determines that the restarting condition is satisfied.

18. The apparatus according to claim 12, wherein if a suspending time is greater than a third preset time threshold, the controlling module determines that the restarting condition is satisfied.

19. The apparatus according to claim 10, comprising:
a non-transitory computer-readable medium comprising computer-executable instructions stored thereon; and
an instruction execution system, which is configured by the instructions to implement at least one of the receiving module, the detecting module and the controlling module.

20. A non-transitory computer readable storage medium, comprising a computer program stored thereon, which when executed by a controller of the water dispenser, configures the water dispenser to implement a method for controlling a cooling in a water dispenser, the method comprising acts of:
S1, receiving a cooling instruction and entering a cooling mode according to the cooling instruction;
S2, obtaining an operation parameter of the water dispenser;
S3, determining whether a suspending condition is satisfied according to the operation parameter;
S4, suspending a cooling if the suspending condition is satisfied; and
S5, further determining whether a restarting condition is satisfied, if the restarting condition is satisfied performing the cooling, and executing steps S2-S5 repeatedly until a cooling terminating condition is satisfied.
